(19) United States
(12) Patent Application Publication
(10) Pub. No.: US 2005/0088523 A1
(43) Pub. Date: Apr. 28, 2005

(54) Burglarproof security system

(75) Inventors: Bing-Fei Wu, Hsinchu City (TW); Chao-Jung Chen, Taipei City (TW); Hsin-Yuan Peng, Taitung City (TW)

Correspondence Address: BACON & THOMAS, PLLC, 625 SLATERS LANE, FOURTH FLOOR, ALEXANDRIA, VA, 22314, US

(73) Assignee: National Chiao Tung University, Hsinchu City (TW)

(21) Appl. No.: 10/867,724

(22) Filed: Jun. 16, 2004

(30) Foreign Application Priority Data
Oct. 24, 2003 (TW) 092129555

(51) Int. Cl. H04N 7/18

(52) U.S. Cl. 348/152; 348/143

(57) ABSTRACT

A burglarproof security system is disclosed, wherein a video for a target object is recorded and transmitted to a mobile device at the far end at the first time via a wireless communication. The mobile device has a display device for displaying the video, so that a user can monitor and assure the safety of the target object.

### BACKGROUND OF THE INVENTION

1. Field of the Invention

The present invention relates to a security system and, more particularly, to a security system which transmits a video or an image via wireless communication to protect a property against intruders, thieves, etc.

2. Description of Related Art

For protection of property, a security device is usually disposed for detecting an intrusion and notifying the security person of such. Referring to FIG. 1, the security device 50 of the prior art includes the components as follows:

A vibration sensor 52 senses vibrations of a movable object, such as a car, or intrusions to an immovable property, such as a house. When a thief breaks into a car, it usually causes certain vibration, which can be detected by the vibration sensor 52 to output a vibration alarm signal to a third micro processor 56. Moreover, the vibration sensor 52 can be placed at an appropriate place of an immovable property, such as window or door of a house, for providing vibration detection.

An infrared sensor 54 is used to detect movement of an object. Because infrared is invisible without special equipment, the thief is not able to avoid breaking the passage of the infrared beams. Therefore, the infrared sensor 54 can no longer receive the infrared beam and thus an infrared interruption signal is output from the infrared sensor 54 to the third processor 56.

The third processor 56 receives the vibration alarm signal and the infrared detection signal and outputs a trigger signal to an alarm 58 to scare the intruder.

The alarm 58 can be a buzzer, flashing light or their combination, whereby the light/sound etc. not only scares the intruder but also alerts the user off the break in.

However, the detection by the security device 50 is not precise or reliable. For example, if a pet is left in a car and its movement is detected by the security device 50, a false alarm is generated to cause confusion to the user. If the user can receive a real-time image or video of the property, it would be easy to determine whether the warning message is correct or incorrect.

Therefore, it is desirable to provide a burglarproof security system to mitigate and/or obviate the aforementioned problems.

### SUMMARY OF THE INVENTION

It is the main object of the present invention to provide a burglarproof security system which provides a real-time image or video to the user.

It is another object of the present invention to provide a burglarproof security system which can be integrated with an existing security device.

In one aspect of the invention, the burglarproof security system of the present invention includes a security device that provides a function of intruder detection and outputs an alarm signal when detecting an intrusion; at least one video recorder is responsive to output a video according to a camera signal; a first processor is responsive to output the camera signal according to the alarm signal, integrate the video into a media file, and output the media file; a first communication module is responsive to obtain the media file and transmit the media file; a second communication module is responsive to obtain the media file from the first communication module and output the media file; a second processor is responsive to obtain the media file from the first communication module, obtain the video by decoding the media file, and output the video; and a display device is responsive to obtain the video from the second processor and display the video.

In another aspect of the invention, the burglarproof security system of the present invention includes a security device that provides a function of intruder detection and outputs an alarm signal when detecting an intrusion; at least one video recorder is responsive to output a video according to a camera signal; a first processor is responsive to output the camera signal according to the alarm signal, integrate the video into a media file, and output the media file; a wired communication module is responsive to obtain and output the media file; a telecommunication server is responsive to obtain the media file from the wired communication module and transmit the media file; a wireless communication module is responsive to obtain the media file from the telecommunication server and output the media file; a second processor is responsive to obtain the media file from the wireless communication module, obtain the video by decoding the media file, and output the video; and a display device is responsive to obtain the video from the second processor and display the video.

Other objects, advantages, and novel features of the invention will become more apparent from the following detailed description when taken in conjunction with the accompanying drawings.

### BRIEF DESCRIPTION OF THE DRAWINGS

FIG. 1 shows a block diagram of a prior art security device;

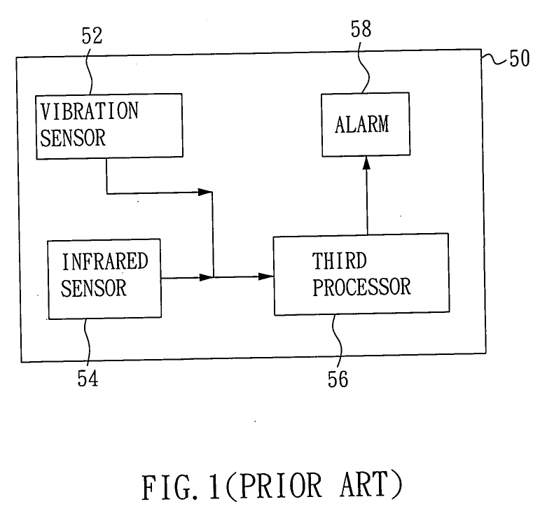

FIG. 2 shows a block diagram of an embodiment of a burglarproof security system in accordance with the present invention; and

FIG. 3 shows a block diagram of another embodiment of a burglarproof security system in accordance with the present invention.

### DETAILED DESCRIPTION OF THE PREFERRED EMBODIMENT

Now, the present invention will be described in greater detail by referring to the accompanying drawings that illustrate the preferred embodiment of the invention, although the present invention is by no means limited thereto.

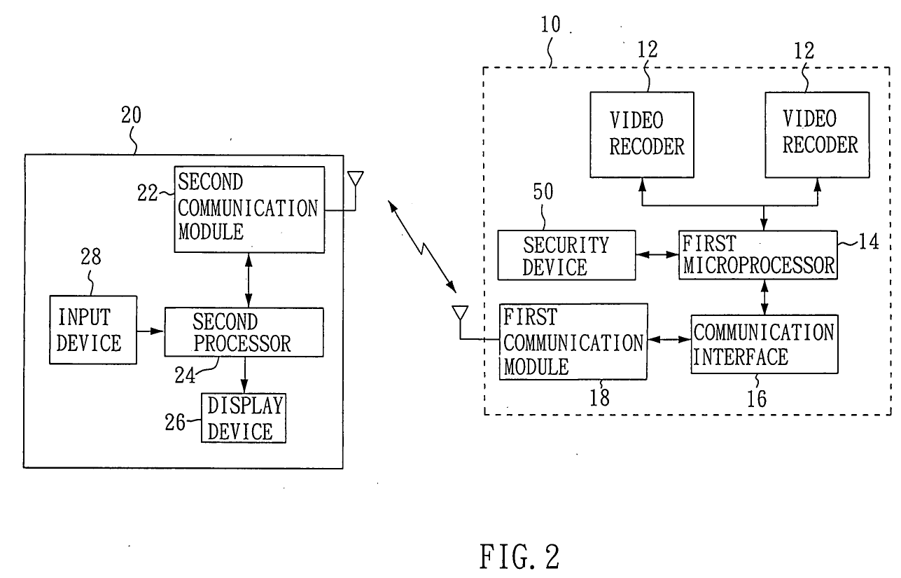

A burglarproof security system in accordance with the present invention records a video and transmits the video to a mobile device via wireless communication. Therefore, a user can determine whether property, such as a car or a house, has been intruded by an unauthorized person. With reference to FIG. 2, the embodiment of the burglarproof security system in accordance with the present invention includes the components as follows:

A first monitor 10 provides a function of intruder detection and video transmission, which further includes the following components:

A security device 50 provides a function of intruder detection. When detecting an unusual vibration or movement of an object, the security device 50 outputs an alarm signal to a first processor 14. The security device 50 is similar to the one described in the prior art, and thus a detailed description is deemed unnecessary.

The first processor 14 is used to receive an alarm signal and run a process. When receiving the alarm signal, the first processor 14 not only outputs an image capturing signal to a video recorder 12 and obtains a video from the video recorder 12, but also integrates the video into an MMS (Multimedia Message Service) and outputs the MMS to a communication interface 16. The first processor 14 can also attach the video to an email message and output the email to the communication interface 16.The video recorder 12 is used to record the video image. When receiving an image capturing signal, the video recorder 12 starts to record the video and outputs the video immediately. If the video recorder 12 receives an image capturing cancellation signal, the video image is no longer recorded and not outputted anymore. The video recorder 12 includes one or more video recorders. Preferably, the video recorder 12 includes two video recorders.

The communication interface 16 is used to obtain the MMS (or email) from the first processor 14 and to transmit those messages to a first communication module 18. The communication interface 16 is preferred to be an RS-232, USB (Universal Serial Bus) or IEEE 1394 (FireWire).

The first communication module 18 is used to communicate with a second communication module 22 in a wireless manner. The interface and protocol of the first communication module 18 are matched with those of the second communication module 22. The first communication module 18 could be a GPRS (General Package Radio Service) module, a 3G (third generation cellular system) module, a WiFi module or Bluetooth module for supporting a wireless communication. When obtaining the MMS, the first communication module 18 transmits the MMS to a mobile device 20 at a far end. Moreover, the first communication module 18 also can receive an SMS (Short Message Service) from the second communication module 22 and output the SMS to the communication interface 16.

The mobile device 20 is at the far end and held by the user, and is preferred to be a PDA (Personal Digital Assistant), cellular phone, smart phone, notebook computer or mobile computer. The mobile device 20 includes the following components:

A second communication module 22 is used to communicate with and receive the MMS from the first communication module 18 of the first monitor 10 and to output the MMS to the second processor 24.

A second processor 24 is used to obtain and decode the MMS to obtain the corresponding video for output to a display device 26.

The display device 26 is used to display image or video to the user. Hence, the user can see a real-time image or video and determine the status of the car or house. In addition, the second processor 24 also can trigger a buzzer, flashing light or such apparatus for alerting the user.

An input device 28 is preferred to be a touch pad, keyboard or mouse, and used to output a configuration signal set by the user to the second processor 24. When obtaining the configuration signal, the second processor 24 integrates the configuration signal into a SMS and outputs the SMS to the first processor 14 via the second communication module 22, the first communication module 18 and the communication interface 16. The first processor 14 gets the configuration signal from the SMS and outputs a camera signal to the video recorder 12, and then the video recorder 12 starts to record and output the video. Therefore, the second processor 24 can request the first processor 14 to output the video to the mobile device 20 without an alarm signal. It is well known that the first processor 14 also can stop recording the video in accordance with the configuration signal. The configuration signal can also be integrated into an email.

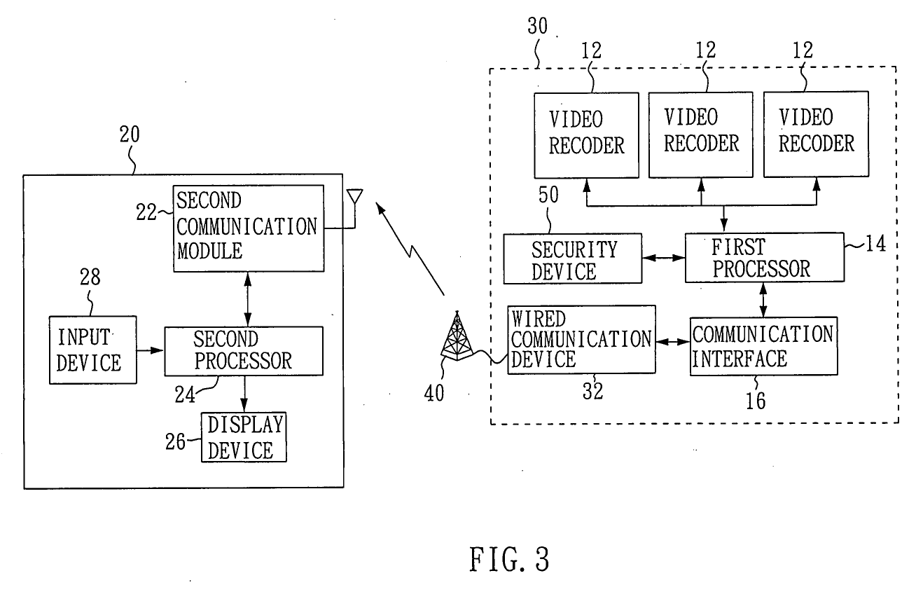

With reference to FIG. 3, a second embodiment of the burglarproof security system in accordance with the present invention is shown, which is similar to the first embodiment except that the second embodiment transmits the MMS and SMS via a wired communication. Hence, the communication interface 16 outputs the MMS to a wired communication device 32, instead of the first communication module 18, and the MMS is transmitted to the second processor 24 via a wired communication device 32, a telecommunication server 40 and the second communication module 22, and vice versa. The wired communication device 32 is preferred to be a modem of broad band or narrow band.

Although the present invention has been explained in relation to its preferred embodiment, it is to be understood that many other possible modifications and variations can be made without departing from the spirit and scope of the invention as hereinafter claimed.

1. A burglarproof security system, comprising:
a security device responsive to provide a function of intruder detection and output an alarm signal when detecting an intrusion;
at least one video recorder responsive to output a video according to a camera signal;
a first processor responsive to output the camera signal according to the alarm signal, integrate the video into a media file, and output the media file;
a first communication module responsive to obtain the media file and transmit the media file;
a second communication module responsive to obtain the media file from the first communication module and output the media file;
a second processor responsive to obtain the media file from the second communication module, obtain the video by decoding the media file, and output the video; and
a display device responsive to obtain the video from the second processor and display the video.

2. The system as claimed in claim 1, further comprising a communication interface for obtaining the media file from the first processor and outputting the media file to the first communication module.

3. The system as claimed in claim 1, further comprising an input device for outputting a configuration signal to the second processor, the second processor integrating the configuration signal into a message file, the message file being output to the first processor via the second communication module and the first communication module, the first processor decoding the message file and outputting the camera signal to enable or disable the at least one video recorder.

4. The system as claimed in claim 3, wherein the media file and the message file are MMS, SMS or email.

5. The system as claimed in claim 3, wherein the first communication module and the second communication module are GPRS, 3G, WiFi or Bluetooth module.

6. A burglarproof security system, comprising:
a security device to provide a function of intruder detection and output an alarm signal when detecting an intrusion;
at least one video recorder responsive to output a video according to a camera signal;
a first processor responsive to output the camera signal according to the alarm signal, integrate the video into a media file, and output the media file;
a wired communication module responsive to obtain and output the media file;
a telecommunication server responsive to obtain the media file from the wired communication module and transmit the media file;
a wireless communication module responsive to obtain the media file from the telecommunication server and output the media file;
a second processor responsive to obtain the media file from the wireless communication module, obtain the video by decoding the media file, and output the video; and
a display device responsive to obtain the video from the second processor and display the video.

7. The system as claimed in claim 6, further comprising a communication interface for obtaining the media file from the first processor and outputting the media file to the wired communication module.

8. The system as claimed in claim 6, further comprising an input device for outputting a configuration signal to the second processor, the second processor integrating the configuration signal into a message file, the message file being output to the first processor via the wireless communication module, the telecommunication server and the first communication module, the first processor decoding the message file and outputting the camera signal to enable or disable the at least one video recorder.

9. The system as claimed in claim 8, wherein the media file and the message file are MMS, SMS or email.

10. The system as claimed in claim 8, wherein the wireless communication module is a GPRS, 3G, WiFi or Bluetooth module.
